(19) United States
(12) Patent Application Publication
(10) Pub. No.: US 2021/0172465 A1
(43) Pub. Date: Jun. 10, 2021

(54) SUPPORT CLIP

(71) Applicant: Andrew Hascall McGrath, Lafayette, CA (US)

(72) Inventor: Andrew Hascall McGrath, Lafayette, CA (US)

(21) Appl. No.: 16/705,154

(22) Filed: Dec. 5, 2019

(51) Int. Cl. F16B 2/06; F16M 13/02; E04B 1/41

(52) U.S. Cl. CPC F16B 2/065; E04B 2001/405; E04B 1/40; F16M 13/022

(57) ABSTRACT

A support clip for holding one or more plates is disclosed. The support clip comprises a first element and a second element. The first element having a clamping jaw at a first end of the support clip, for holding one or more plates, a first clip body at a second end of the support clip, and at least a first hole. Further, the second element having a second clip body at the second end of the support clip and at least a second hole. Further, the first element and the second element are coupled, by a fastener, through at least the first hole and at least the second hole, and thereby forming the support clip for securing a support frame.

### FIELD OF THE DISCLOSURE

The present disclosure is generally related to a support clip, and more particularly related to clamp-on style glass support clips.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Modern architecture and construction requires holding various plates such as glass panes, metal plates, or stone plates, against a support frame. The plates are drilled and bolted onto the support frame. However, drilling is not possible in case of the glass panes. Currently, various clamping devices are used, for example, a bolt-on style clip holds glass. However, installation of such clamping devices requires skilled knowledge. Further, the installation of such clamping devices requires specialized power tools such as heavy drills.

In another example, a clip that clamps on a support frame is designed to support another support frame. Further, removal of such clamping devices leaves holes and deformities on the support frame, making the support frame weak. Further, manufacturers of the support frame need to specify a hole or a thread for mounting such clamping devices. In a case, where the hole or the thread is not specified by the manufacturer, a hole must be introduced later during assembly which requires a lot of effort. In another case, the plates are installed only at earlier specified location on the support frames.

Therefore, there is a need for an improved design of a bracket or support clip for holding plates and mounting on a support frame easily and without the use of power tools or skilled knowledge.

### SUMMARY OF THE INVENTION

According to embodiments illustrated herein, a support clip for holding one or more plates is disclosed. The support clip includes a first element and a second element. The first element having a clamping jaw at a first end of the support clip, for holding one or more plates, a first clip body at a second end of the support clip, and at least a first hole. On the other hand, the second element having a second clip body at the second end of the support clip, and at least a second hole. Thereafter, the first element and the second element are coupled, by a fastener, through at least the first hole and at least the second hole, and thereby forming the support clip for securing a support frame.

According to embodiments illustrated herein, a support clip for holding one or more plates is disclosed. The support clip includes a first element and a second element. The first element includes a first clamping jaw at a first end of the support clip, a first clip body at a second end of the support clip, and at least a first hole. On the other hand, the second element having a second clamping jaw at the first end of the support clip, a second clip body at the second end of the support clip, and at least a second hole. Further, the first element and the second element are coupled, by a fastener, through at least the first hole and at least the second hole, and thereby forming the support clip for securing a support frame.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1A illustrates a perspective view of a support clip 100, according to an embodiment.

FIG. 1B illustrates an exemplary scenario of the support clip 100, according to an embodiment.

FIG. 2 illustrates a perspective view of a support clip 200, according to an embodiment.

FIG. 3A illustrates a perspective view of a support clip 300, according to an embodiment.

FIGS. 3B and 3C illustrate an exemplary scenario of the support clip 300, according to an embodiment.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

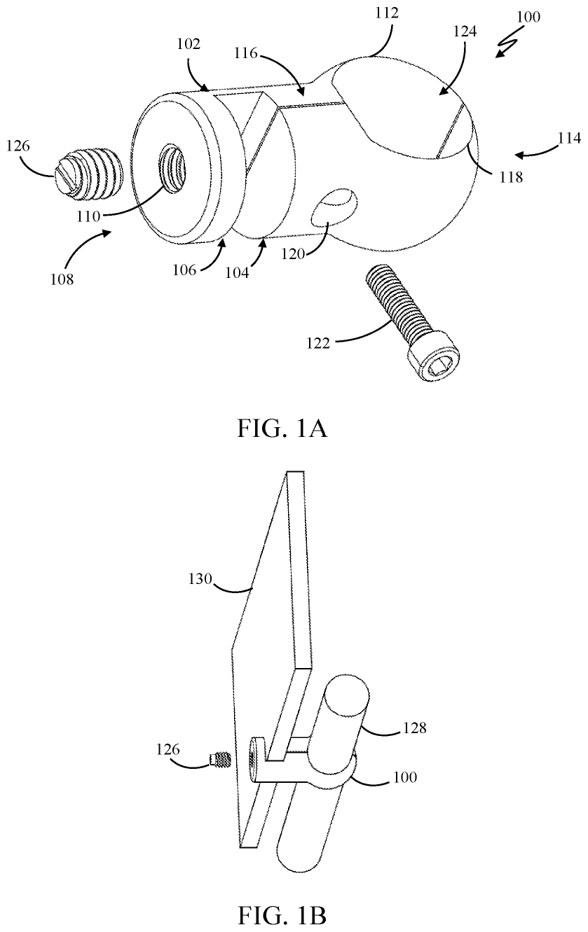

FIG. 1 illustrates a perspective view of a support clip 100, according to an embodiment. The support clip 100 may include a first element 102 and a second element 104. The first element 102 may have a clamping jaw 106 at a first end 108 of the support clip 100. The clamping jaw 106 may include a threaded hole 110 i.e., a through hole. Further, the first element 102 may include a first clip body 112 at a second end 114 of the support clip 100. The first clip body 112 having a semicircular arc shape. Further, the first element 102 may include at least a first hole 116 on an inner surface of the first element 102. In one case, at least the first hole 116 may be a threaded hole.

On the other hand, the second element 104 having a second clip body 118 at the second end 114 of the support clip 100. The second clip body 118 having a semicircular arc shape. Further, the second element 104 having at least a second hole 120. In one case, at least the second hole 120 may be a through hole and a threaded hole. Further, the first element 102 and the second element 104 may be coupled together by a fastener 122, through at least the first hole 116 and at least the second hole 120. The fastener 122 may be a socket screw. In one case, the socket screw may be made up of stainless steel. Such coupling of the first element 102 and the second element 104 may form the support clip 100. Thereafter, the support clip 100 may be clamped on a support frame 128, as shown in FIG. 1B. It should be noted that the first clip body 112 and the second clip body 118 may be used for securing the support frame 128.

In one embodiment, when the first element 102 and the second element 104 are coupled together, then a space 124 may be formed between the first clip body 112 and the second clip body 118. The space 124 may be used to clamp the support clip 100 on the support frame 128. In another embodiment, the first element 102 and the second element 104 may be placed on either side of the support frame 128 in such a way that on tightening the fastener 122, the first element 102 and the second element 104 are coupled together to clamp the support clip 100 around the support frame 128. Further, the clamping jaw 106 of the first element 102 may be used for holding a plate i.e., one or more plates 130 perpendicular to the support frame 128, as shown in FIG. 1B. The one or more plates 130 may be tightened by inserting a set screw (i.e., a locking set screw) 126 in the threaded hole 110. The set screw 126 may be made up of a compressional plastic or nylon. It should be noted that the one or more plates 130 may correspond to at least a panel such as glass panel, metal panel, or stone panel, without departing from the scope of the disclosure.

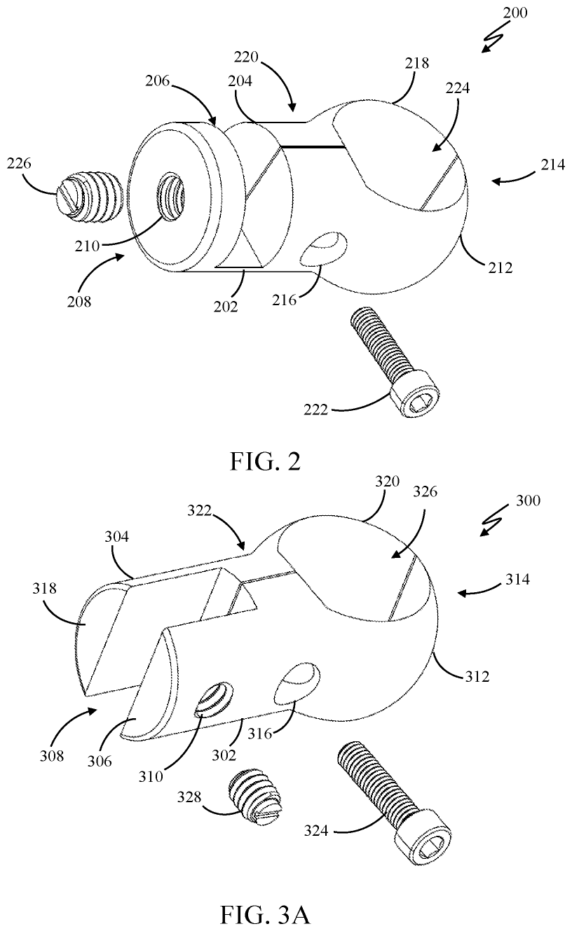

FIG. 2 illustrates a perspective view of a support clip 200, according to an embodiment. The support clip 200 may include a first element 202 and a second element 204. The first element 202 may have a clamping jaw 206 at a first end 208 of the support clip 200. The clamping jaw 206 may include a threaded hole 210 i.e., a through hole. Further, the first element 202 may include a first clip body 212 at a second end 214 of the support clip 200. The first clip body 212 having a semicircular arc shape. Further, the first element 202 may include at least a first hole 216. It should be noted that at least the first hole 216 may be a through hole and a threaded hole, as shown in FIG. 2.

On the other hand, the second element 204 having a second clip body 218 at the second end 214 of the support clip 200. The second clip body 218 having a semicircular arc shape. Further, the second element 204 having at least a second hole 220 on an inner surface of the second element 204. It should be noted that at least the second hole 220 may be a threaded hole. Further, the first element 202 and the second element 204 may be coupled together by a fastener 222, through at least the first hole 216 and at least the second hole 220. The fastener 222 may be a socket screw. The socket screw may be made up of stainless steel. Such coupling of the first element 202 and the second element 204 may form the support clip 200. Thereafter, the support clip 200 may be clamped on a support frame (not shown). It should be noted that the first clip body 212 and the second clip body 218 may be used for securing the support frame.

In one embodiment, when the first element 202 and the second element 204 are coupled together, then a space 224 may be formed between the first clip body 212 and the second clip body 218. The space 224 may be used to clamp the support clip 200 on the support frame. In another embodiment, the first element 202 and the second element 204 may be placed on either side of the support frame in such a way that on tightening the fastener 222, the first element 202 and the second element 204 are coupled together to clamp the support clip 200 around the support frame. Further, the clamping jaw 206 of the first element 202 may be used for holding a plate (not shown) parallel to the support frame. The plate may be tightened by inserting a set screw (i.e., a locking set screw) 226 in the threaded hole 210. The set screw 226 may be made up of a compressional plastic or nylon. It should be noted that the plate may correspond to at least a panel, without departing from the scope of the disclosure.

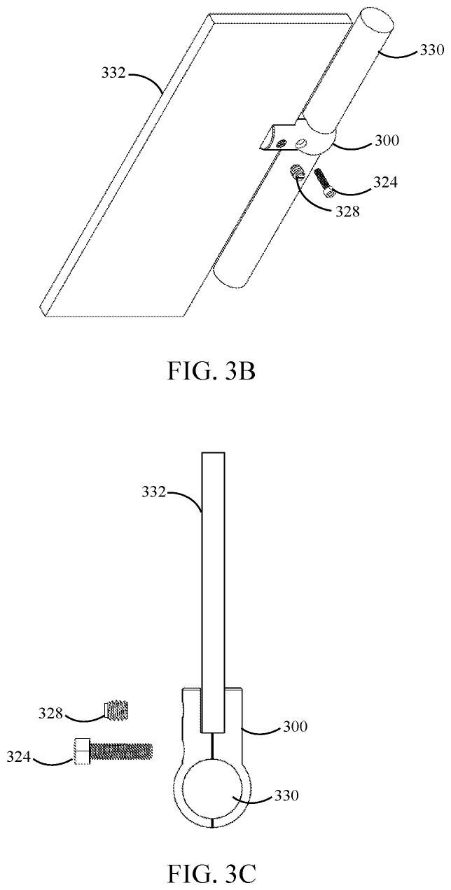

FIG. 3 illustrates a perspective view of a support clip 300, according to an embodiment. The support clip 300 may include a first element 302 and a second element 304. The first element 302 may have a first clamping jaw 306 at a first end 308 of the support clip 300. The first clamping jaw 306 may include a threaded hole 310 i.e., a through hole. Further, the first element 302 may include a first clip body 312 at a second end 314 of the support clip 300. The first clip body 312 having a semicircular arc shape. Further, the first element 302 may include at least a first hole 316. It should be noted that at least the first hole 316 may be a threaded hole and a through hole.

On the other hand, the second element 304 may have a second clamping jaw 318 at the first end 308 of the support clip 300. In one case, the second clamping jaw 318 may include a threaded hole. Further, the second element 304 having a second clip body 320 at the second end 314 of the support clip 300. The second clip body 320 having a semicircular arc shape. Further, the second element 304 having at least a second hole 322 on an inner surface of the second element 304. In one case, at least the second hole 322 may be a threaded hole. Further, the first element 302 and the second element 304 may be coupled together by a fastener 324, through at least the first hole 316 and at least the second hole 322. The fastener 324 may be a socket screw. The socket screw may be made up of stainless steel. Such coupling of the first element 302 and the second element 304 may form the support clip 300. Thereafter, the support clip 300 may be clamped on a support frame 330, as shown in FIGS. 3B and 3C. It should be noted that the first clip body 312 and the second clip body 320 may be used for securing the support frame 330.

In one embodiment, when the first element 302 and the second element 304 are coupled together, then a space 326 may be formed between the first clip body 312 and the second clip body 320. The space 326 may be used to clamp the support clip 300 on the support frame 330. In another embodiment, the first element 302 and the second element 304 may be placed on either side of the support frame 330 in such a way that on tightening the fastener 324, the first element 302 and the second element 304 are coupled together to clamp the support clip 300 around the support frame 330. Further, the first clamping jaw 306 and the second clamping jaw 318 may be used for holding a plate i.e., one or more plates 332, as shown in FIGS. 3B and 3C. The one or more plates 332 may be tightened by inserting a set screw (i.e., a locking set screw) 328 in the threaded hole 310. The set screw 328 may be made up of a compressional plastic or nylon. It should be noted that the one or more plates 332 may correspond to at least a panel, without departing from the scope of the disclosure.

The support clips 100, 200, and 300 may be made up of a material selected from the group of materials consisting of a metal, an alloy, a glass, a plastic, or a wood. For example, the support clips 100, 200, and 300 may be made up of aluminum. In one embodiment, the support clips 100, 200, and 300 may be made up of some other materials and designed to support a ranging thickness of materials, without departing from the scope of the disclosure.

The disclosed embodiments encompass numerous advantages. Various embodiments of support clips for securing a support frame have been disclosed. Such supports clips may be tightened or locked onto the support frame. Such support clips have an ability to be mounted onto the support frame without the use of power tools or skilled knowledge. Further, such support clips improve speed and ease of use by allowing the support clips to be inventoried and assembled on-site. Further, the supports clips may be designed as per the requirements at any time and location. Additionally, the support clips may hold plates of various thickness and the plates may be mounted parallel, perpendicular, or co-planar to the support frame. It should be noted that the support clips may be rotated perpendicular to the support frame. Furthermore, the plates may be removed and re-located at any time without requiring any power tools and/or skilled knowledge and therefore the removal of the support clips may leave no holes, marks, or deformities on the support frame.

Further, the support clips may be removed and reinstalled as needed with no actual ware visible on the support clip. Therefore, such designs of one-piece support clips are optimal and results in increasing speed of the mounting without the use of power tools or skilled knowledge.

The features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope.

Features that are described and/or illustrated with respect to one embodiment may be used in the same way or in a similar way in one or more other embodiments and/or in combination with or instead of the features of the other embodiments.

While the preferred embodiment of the present invention has been illustrated and described, as noted above, many changes can be made without departing from the spirit and scope of the invention. For example, aspects of the present invention may be adopted on alternative operating systems. Accordingly, the scope of the invention is not limited by the disclosure of the preferred embodiment. Instead, the invention should be determined entirely by reference to the claims that follow.

1. A support clip comprising:
a first element having:
a clamping jaw at a first end of the support clip, for holding one or more plates;
a first clip body at a second end of the support clip; and
at least a first hole; and
a second element having:
a second clip body at the second end of the support clip; and
at least a second hole,
wherein the first element and the second element are coupled, by a fastener, through at least the first hole and at least the second hole, and thereby forming the support clip for securing a support frame.

2. The support clip of claim 1, wherein the clamping jaw comprises a threaded hole.

3. The support clip of claim 2, wherein the one or more plates are tightened by inserting a set screw in the threaded hole.

4. The support clip of claim 1, wherein the one or more plates correspond to at least a panel.

5. The support clip of claim 1, wherein the first clip body and the second clip body having a semicircular arc shape.

6. A support clip comprising:
a first element having:
a first clamping jaw at a first end of the support clip;
a first clip body at a second end of the support clip; and
at least a first hole; and
a second element having:
a second clamping jaw at the first end of the support clip;
a second clip body at the second end of the support clip; and
at least a second hole,
wherein the first element and the second element are coupled, by a fastener, through at least the first hole and at least the second hole, and thereby forming the support clip for securing a support frame.

7. The support clip of claim 6, wherein the first clamping jaw comprises a threaded hole.

8. The support clip of claim 7, wherein the one or more plates are tightened by inserting a set screw in the threaded hole.

9. The support clip of claim 6, wherein the first clamping jaw and the second clamping jaw are coupled together, for holding one or more plates.

10. The support clip of claim 6, wherein the one or more plates correspond to at least a panel.

11. The support clip of claim 6, wherein the first clip body and the second clip body having a semicircular arc shape.
